(19) United States
(12) Patent Application Publication
(10) Pub. No.: US 2013/0261848 A1
(43) Pub. Date: Oct. 3, 2013

(54) SYSTEMS AND METHODS FOR PROVIDING NONPROTECTED-AREA AWARENESS AND ALERTING

(71) Applicant: Ratan Khatwa, Sammamish, WA (US)

(72) Inventor: Ratan Khatwa, Sammamish, WA (US)

(73) Assignee: HONEYWELL INTERNATIONAL INC., Morristown, NJ (US)

(21) Appl. No.: 13/436,647

(22) Filed: Mar. 30, 2012

(51) Int. Cl. G06F 17/00

(52) U.S. Cl. 701/3

(57) ABSTRACT

Systems and methods for providing nonprotected-area awareness and alerting to a crew of a vehicle. An exemplary system determines a safe region based on the received previously defined route based on controlling authority requirements associated with the route, identifies at least one non-safe region based on the determined safe region and then uniquely presents the identified at least one non-safe region on a display such as a moving map display (2D or 3D).

### BACKGROUND OF THE INVENTION

It is well documented that controlled flight into terrain (CFIT) and approach and landing accidents (ALAs) continue to dominate the fatal accident categories. In many cases, flight crews appeared to lack knowledge of the design criteria for the instrument-approach procedures that they were flying.

There are limitations of the instrument procedure design that pilots should be familiar with. Without understanding of these limitations/protections, pilots could inadvertently place the aircraft in a situation where safe terrain separation is compromised. The U.S. standard used to guide instrument-procedure design is the Federal Aviation Administration (FAA) Standard for Terminal Instrument Procedures (TERPS), and its International Civil Aviation Organization (ICAO) equivalent is Procedures for Air Navigation Services-Aircraft Operations (PANS-OPS). There are known differences between these standards that flight crews may not always be aware of.

Thus, there exist potential hazards associated with circling approaches. TERPS states that the protected area for Category C aircraft could provide only 300 feet of obstacle clearance within 1.7 nm of the thresholds of the runways suitable for use. PANS-OPS provides a minimum of 394 feet of obstacle clearance within 4.2 nm of the runway thresholds. It may not always be clear to a pilot whether a procedure is TERPS or PANS-OPS.

### SUMMARY OF THE INVENTION

The present invention provides a set of requirements to enhance existing systems such as the enhanced ground proximity warning system (EGPWS) and digital data charts (DDC) for improving pilot awareness. DDCs provide the necessary routing and procedure information for departure (SID), arrival (STAR), and approach (IAP) integrated with a navigation moving map display. Electronic navigation information is integrated with flight management system (FMS) flight plan information. The present invention fosters the integration of data from multiple independent systems, such as GPS, FMS, EGPWS, and DDC.

TERPS or PANS-OPS criteria are presented on a navigation display (ND) for a flight phase procedure (e.g., an approach or other flight phase procedure), once the procedure is selected within the FMS. This could also be rendered as part of a DDC display.

### BRIEF DESCRIPTION OF THE DRAWINGS

Preferred and alternative embodiments of the present invention are described in detail below with reference to the following drawings:

FIG. 1 is a block diagram of an exemplary system formed in accordance with an embodiment of the present invention;

FIG. 2 is a flow chart of an exemplary process performed by the system shown in FIG. 1;

FIGS. 3 and 4 show exemplary two-dimensional moving map displays as generated by the system shown in FIG. 1; and

FIG. 5 shows an exemplary three-dimensional display as generated by the system shown in FIG. 1.

### DETAILED DESCRIPTION OF THE INVENTION

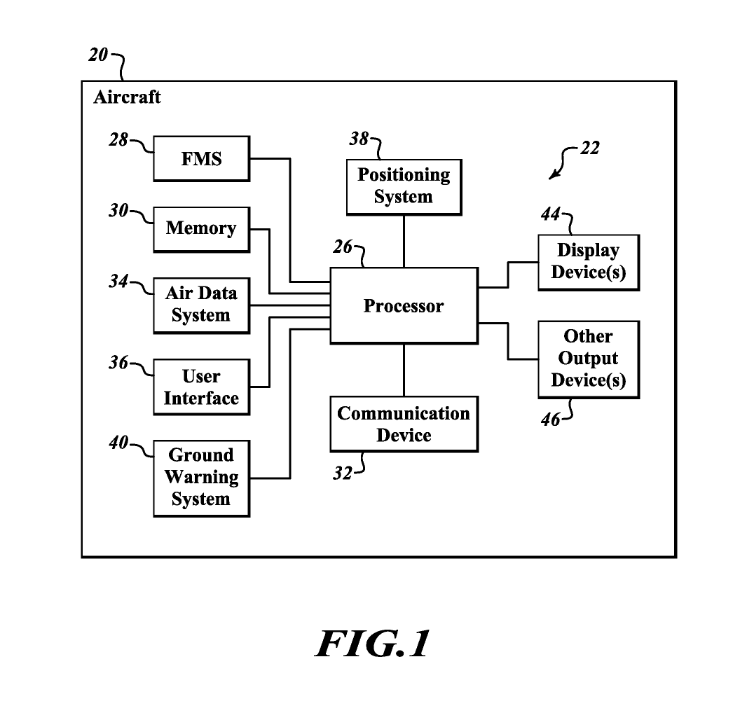

FIG. 1 shows an exemplary system 22 located on an aircraft 20 for automatically identifying and presenting nonprotected areas of an instrument approach based on the standards terminal instrument procedures (TERPS) and the procedures for air navigation services-aircraft operations (PANS-OPS). Although the description herein includes the approach phase, similar protection could be provided in other flight phases such as arrival, departure and en-route segments. The system 22 includes a data processor 26 in data communication with a flight management system (FMS) 28, a positioning system 38, memory 30, an air data system (ADS) 34, a user interface 36, a communication device 32 (optional), a Ground (or obstacle) Warning System 40 and display device(s) 44 and/or other type of output device(s) 46.

The processor 26 receives position information, map information, and previously or automatically selected approach (or other flight phase) information from the positioning system 38, the memory 30, the FMS 28, and/or air traffic control (ATC) via the communication device 32. Based on the received information, the processor 26 presents a display of the selected approach and areas (i.e., volumes) around the approach that are not considered protected according to the standard (TERPS or PANS-OPS) associated with the routing and procedure information for departure (SID), arrival (STAR), or approach (IAP) on a navigation moving map display (i.e., the display device 44).

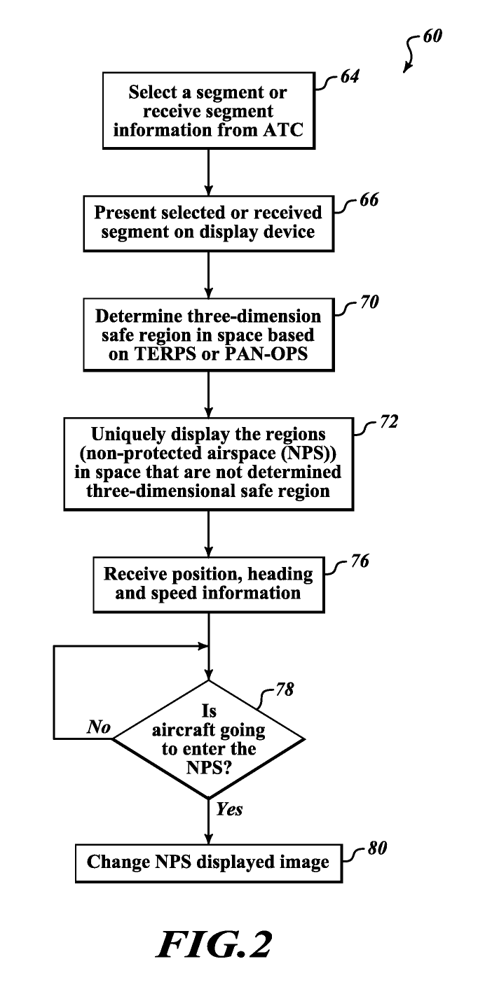

FIG. 2 illustrates an exemplary process 60 performed by the system 22 shown in FIG. 1. First, at a block 64, an arrival, approach, departure or en-route segment is selected by the flightcrew using the user interface 36 or flight segment information is received from ATC via the communication device 32. The flightcrew selects the approach (or other flight plan information) from the memory 30 or the FMS 28.

At a block 66, the flight segment is presented on a navigation moving map on the display device 34. At a block 70, the processor 26 determines any three-dimensional safe regions in space, based on TERPS or PAN-OPS safe operation criteria or similar critera for any flight phase. In one embodiment, the area of protection (i.e., safe region) is a three-dimensional volume of airspace that the aircraft must stay within to ensure safe operation relative to the surrounding terrain. The safe region is defined using the TERPS or PAN-OPS criteria for a given approach or similar criteria for other flight phases. Then, at a block 72, the processor 26 determines regions considered not safe, (nonprotected airspace (NPS)), based on the three-dimensional safe region(s). Once the NPS is determined, the processor 26 uniquely displays the NPS on the display device 44.

Next, at a block 76, the processor 26 receives position, heading, and speed from the positioning system 38 and/or the ADS 34 (or optional inertial navigation system (INS)). Then, at a decision block 78, the processor 26 determines if the aircraft 20 is going to enter the region of airspace associated with the NPS. At a block 80, the processor 26 will alter the uniquely displayed NPS provided that another, more critical, alert (e.g., an enhanced ground proximity warning system (EGPWS)) alert has not been outputted or is predicted to be outputted within a predefined period of time.

In one embodiment, the way in which the NPS is displayed is selectable by the pilot using the user interface 36. This helps a pilot to reduce visual clutter on the display device 44. Texture and color of the displayed NPS are configurable to allow for compliance with flight deck or aircraft operator-specific philosophy.

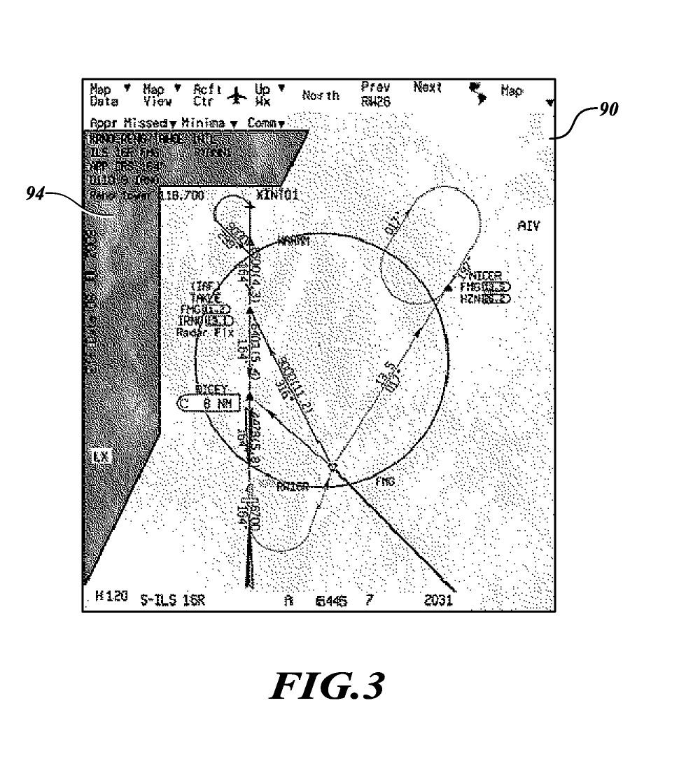

FIG. 3 shows an image 90 of an approach on a navigation (moving map) display with a depiction of an NPS 94. The NPS 94 is presented in a first color and/or pattern when the aircraft has not or will not likely penetrate the volume of space associated with the NPS 94.

If the aircraft track is predicted to penetrate the NPS prior to an EGPWS alert (or other similar terrain awareness and alerting system), an NPS penetration predictive advisory is automatically depicted on the display device 44. In one embodiment, the prediction of the aircraft vector is based on a number of factors including state data, such as groundspeed, track, altitude, and latitude and longitude of aircraft position. The predictive advisory is based on either time or distance to penetration of the NPS.

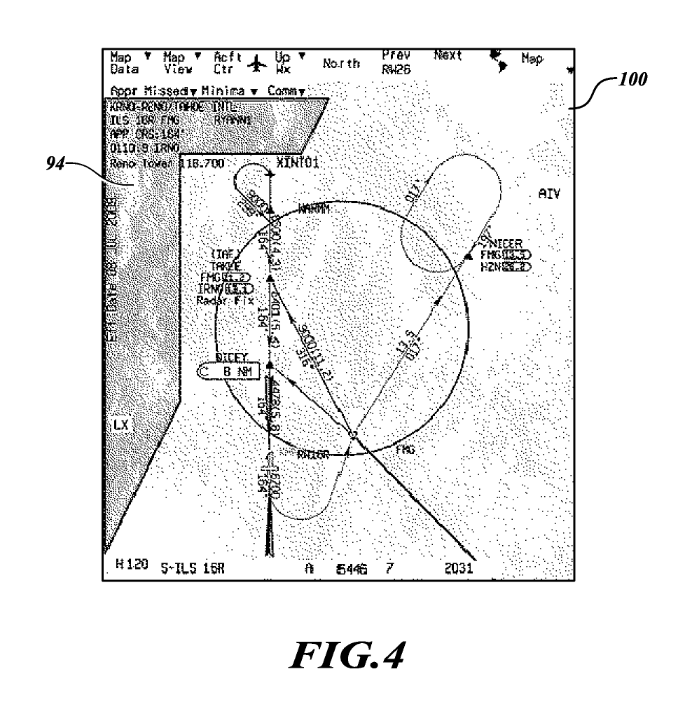

FIG. 4 shows an image 100 of the same approach as shown in FIG. 3, except that it has been determined that the aircraft has penetrated or is likely to penetrate the NPS 94 (i.e., an NPA penetration-predictive advisory). The result is that the visual representation of the NPS 94 is visually altered (e.g., color, intensity, flash rate, pattern, etc.).

In one embodiment, the NPS penetration-predictive advisory is supplemented with an aural advisory cue that the processor 26 outputs via a speaker (the other output device(s) 46).

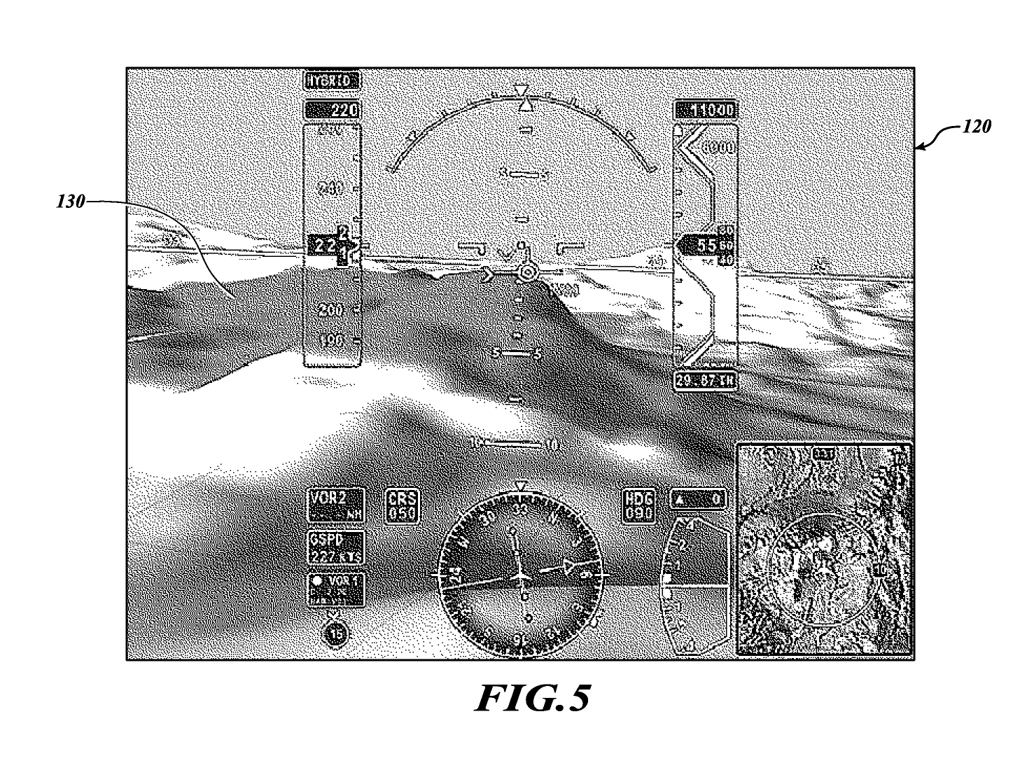

FIG. 5 shows a three-dimensional map display 120 (e.g., SmartView® by Honeywell International Inc.) that depicts an NPS 130 in a unique manner. In this example, the color of the terrain associated with the NPS 130 is shaded red or a color different from non-NPS terrain.

The methods described herein are applicable to Required Navigation Performance (RNP) procedures as well. The area outside the RNP containment area is considered an NPS that must satisfy the TERPS and PAN-OPS criteria.

The present invention also provides depictions of nonprotected airspace for other flight segments such as standard instrument departure (SID) and minimum enroute altitude (MEA) that are dictated by their respective regulation (TERPS and PAN-OPS).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising:
at a processing device,
receiving a previously defined route;
determining a safe region based on the received previously defined route based on controlling authority requirements associated with the route; and
identifying at least one non-safe region based on the determined safe region; and
on a display,
uniquely presenting the identified at least one non-safe region.

2. The method of claim 1, wherein the previously defined route comprises at least one of an approach to landing route, a takeoff route or a maneuvering route.

3. The method of claim 2, wherein receiving the previously defined route comprises at least one of manually receiving the route from a user interface device or automatically receiving the route from a route source via a communication device.

4. The method of claim 1, wherein the uniquely presented at least one non-safe region comprises a three-dimensional image.

5. The method of claim 1, wherein identifying is further based on information associated with at least one of terrain or other obstacles within a threshold distance of the route.

6. The method of claim 1, wherein the processing device and display are located on an aircraft and the controlling authority requirements comprise at least one of Federal Aviation Administration (FAA) standard for Terminal Instrument Procedures (TERPS) or International Civil Aviation Organization (ICAO) Procedures for Air Navigation Services-aircraft Operations (PANS-OPS).

7. The method of claim 1, further comprising:
at the processing device
receiving position, heading, and speed information of an associated vehicle;
determining information related to vehicle penetration into the non-safe region based on information associated with the non-safe region and the received position, heading, and speed information; and
generating an alert based on the determined information,
on the display,
altering the presentation of the identified at least one non-safe region, if an alert has been generated.

8. The method of claim 7, further comprising at the processing device suppressing the generated alert, if a ground proximity warning alert has been generated.

9. A system comprising:
a processing device configured to,
receive a previously defined route;
determine a safe region based on the received previously defined route based on controlling authority requirements associated with the route; and
identify at least one non-safe region based on the determined safe region; and
a display configured to,
uniquely present the identified at least one non-safe region.

10. The system of claim 9, wherein the previously defined route comprises at least one of an approach to landing route, a takeoff route or a maneuvering route.

11. The system of claim 10, further comprising:
a user interface device in communication with the processing device; and
a communication device in communication with the processing device,
wherein the processing device receives the previously defined route from at least one the user interface device or from a route source via a communication device.

12. The system of claim 9, wherein the display presents the at least one non-safe region three-dimensionally.

13. The system of claim 9, further comprising memory configured to store at least one of terrain or other obstacles data,
wherein the processing device identifies further based on the stored terrain data within a threshold distance of the route.

14. The system of claim 9, wherein the system is located on an aircraft and the controlling authority requirements comprise at least one of Federal Aviation Administration (FAA) standard for Terminal Instrument Procedures (TERPS) or International Civil Aviation Organization (ICAO) Procedures for Air Navigation Services-aircraft Operations (PANS-OPS).

15. The system of claim 9, wherein the processing device is further configured to:
receive position, heading, and speed information of an associated vehicle;
determine information related to vehicle penetration into the non-safe region based on information associated with the non-safe region and the received position, heading, and speed information; and
generate an alert based on the determined information,
wherein the display is further configured to present of the identified at least one non-safe region in an altered configuration, if an alert has been generated.

16. The system of claim 15, wherein the processing device is further configure to suppress the generated alert, if a ground proximity warning alert has been generated.

17. A system comprising:
a means for receiving a previously defined route;
a means for determining a safe region based on the received previously defined route based on controlling authority requirements associated with the route;
a means for identifying at least one non-safe region based on the determined safe region; and
a means for uniquely presenting the identified at least one non-safe region.

18. The system of claim 17, wherein the system is located on an aircraft and the controlling authority requirements comprise at least one of Federal Aviation Administration (FAA) standard for Terminal Instrument Procedures (TERPS) or International Civil Aviation Organization (ICAO) Procedures for Air Navigation Services-aircraft Operations (PANS-OPS).

19. The system of claim 17, further comprising:
a means for receiving position, heading, and speed information of an associated vehicle;
a means for determining information related to vehicle penetration into the non-safe region based on information associated with the non-safe region and the received position, heading, and speed information; and
a means for generating an alert based on the determined information,
a means for altering the presentation of the identified at least one non-safe region, if an alert has been generated.

20. The system of claim 19, further comprising a means for suppressing the generated alert, if a ground proximity warning alert has been generated.
